(19) United States
(12) Patent Application Publication
(10) Pub. No.: US 2009/0187520 A1
(43) Pub. Date: Jul. 23, 2009

(54) Demographics from behavior

(76) Inventors: Chao Liu, Redmond, WA (US); Dmitry Yurievich Pavlov, San Jose, CA (US); Nikolai Rochnik, San Mateo, CA (US); Abhinav Gupta, Sunnyvale, CA (US); Mark Steyvers, Irvine, CA (US); Patrick Smyth, Santa Ana, CA (US)

Correspondence Address: BRINKS HOFER GILSON & LIONE / YAHOO! OVERTURE, P.O. BOX 10395, CHICAGO, IL, 60610, US

(21) Appl. No.: 12/011,164

(22) Filed: Jan. 23, 2008

(51) Int. Cl. G06F 15/18

(52) U.S. Cl. 706/21

(57) ABSTRACT

A system and method for modeling online users' behavior for predicting demographic information is disclosed. The system allows advertisement providers to target anonymous users based on a user's browsing history, search queries, as broken down into behavioral targeting categories, as well as other features, such as behavioral targeting segments.

### BACKGROUND

1. Technical Field

The disclosed embodiments relate generally to systems and methods for modeling users' behavior to predict demographic attributes.

2. Background Information

Advertisers who advertise with online advertisement providers such as Yahoo! Search Marketing often target advertisements to potential customers based on historical data of the advertisement provider evidencing relationships between search terms in search queries submitted by logged-in users, demographic information provided by the logged-in user through registration in association with an online account and stored in a cookie, or webpage content in webpages visited by a logged-in user, and interests displayed by those logged-in users. A significant percentage of potential customers navigate the internet without logging in to an account from which advertisement targeting information may be extracted and, thus, their demographic attributes are unknown to the online advertisement providers. For this reason, it would be desirable to have a system and method that can model online users' behavior such that an anonymous user's behavior may give indication of their demographic attributes, to which an online advertisement provider may provide targeted advertisements and other information.

### BRIEF SUMMARY OF THE INVENTION

A method is disclosed for training a user behavior model for predicting demographic attributes of anonymous users. The disclosed method may obtain a user sample data set. The user sample data set may include age information, gender information, behavioral targeting category information, behavioral targeting segment information, search query information, internet protocol (IP) address information, and/or geographic location information. The user sample data set may include a binary vector. The method may include cleaning the user sample data set. The method may include training a user-centric logistic regression model using a quasi-Newton method with the user sample data set. The method may include predicting anonymous user age information and anonymous user gender information by applying test data to the trained user-centric logistic regression model to create a prediction vector for the predicted anonymous user age information and predicted anonymous user gender information. The method may include composing a confusion matrix based on the prediction vector for the anonymous user age information and the anonymous user gender information. The method may include displaying information based on either the prediction vector, the confusion matrix, or both.

In another exemplary embodiment, a method is disclosed for training a user behavior model for predicting demographic attributes of anonymous users. The method may include obtaining a user sample data set. The method may include training a user-centric logistic regression model with the user sample data set. The method may include predicting anonymous user demographic information by applying test data to the trained user-centric logistic regression model. The method may include displaying information based on the predicted anonymous user demographic information.

In another exemplary embodiment, a method is disclosed for predicting demographic attributes for anonymous users. The method may include obtaining a user sample data set. The user sample data set may include age information, gender information, behavioral targeting category information, behavioral targeting segment information, search query information, IP address information, and/or geographic location information. The user sample data set may include a binary vector. The method may include combining duplicate user information within the user sample data set. The method may include removing repeat search query information within the user sample data set. The method may include removing information associated with unknown values within the user sample data set. The method may include removing information associated with high-activity users within the user sample data set. The method may include checking information associated with the user sample data set for balance. The method may include training a user-centric logistic regression model using a quasi-Newton method with the user sample data set. The method may include predicting anonymous user age information and anonymous user gender information by applying anonymous user information to the trained user-centric logistic regression model to create a prediction vector for the predicted anonymous user age information and predicted anonymous user gender information. The anonymous user information may include behavioral targeting category information, behavioral targeting segment information, search query information, IP address information, and/or geographic location information. The method may include sending information based on the prediction vector.

In another exemplary embodiment, a system is disclosed for training a user behavior model for predicting demographic attributes of anonymous users. The system may include an interface configured to obtain a user sample data set. The system may include a training module configured to train a user-centric logistic regression model with the user sample data set. The system may include a predicting module configured to predict anonymous user demographic information by applying test data to the trained user-centric logistic regression model. The system may include a display configured to display information based on the predicted anonymous user demographic information.

In another exemplary embodiment, a system is disclosed for predicting demographic attributes of anonymous users. The system may include an obtaining interface configured to obtain a user sample data set. The user sample data set may include age information, gender information, behavioral targeting category information, behavioral targeting segment information, search query information, IP address information, and/or geographic location information. The user sample data set may include a binary vector. The system may include a pre-processing module. The pre-processing module may be configured to combine duplicate user information within the user sample data set. The pre-processing module may be configured to remove repeat search query information within the user sample data set. The pre-processing module may be configured to remove information associated with unknown values within the user sample data set. The pre-processing module may be configured to remove information associated with high-activity users within the user sample data set. The pre-processing module may be configured to check information associated with the user sample data set for balance. The system may include a training module configured to train a user-centric logistic regression model using a quasi-Newton method with the user sample data set. The system may include a predicting module configured to predict anonymous user age information and anonymous user gender information by applying anonymous user information to the trained user-centric logistic regression model to create a prediction vector for the predicted anonymous user age information and predicted anonymous user gender information. The anonymous user information may include behavioral targeting category information, behavioral targeting segment information, search query information, IP address information, and/or geographic location information. The system may include a sending interface configured to send information based on the prediction vector.

Other systems, methods, features, and advantages will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWINGS

FIG. 1 is a block diagram of one embodiment of an environment in which a system for modeling users' behavior to predict demographic attributes may operate;

FIG. 2 is a flow chart of one embodiment of a method of creating a prediction model for user demographics;

FIG. 3 is an illustration of an exemplary age information binary vector;

FIG. 4 is an illustration of an exemplary gender information binary vector;

FIG. 5 is an illustration of an exemplary demographic information prediction probability vector;

FIG. 6 is a flow chart of one embodiment of a method of creating a prediction model for user demographics;

FIG. 7 is a flow chart of one embodiment of cleaning a sample data set;

FIG. 8 is an illustration of an exemplary reach percentage versus precision percentage graph in accordance with a performing model analysis step;

FIG. 9 is an illustration of an exemplary confusion matrix for a precision reach in accordance with a performing model analysis step; and

FIG. 10 is a block diagram of a computer system used in implementing a system for modeling users' behavior for predicting demographic behavior.

### DETAILED DESCRIPTION

The present disclosure relates to a system and method, generally referred to as a system, related generally to modeling users' behavior to predict a user's demographic attributes. The principles described herein may be embodied in many different forms. The disclosed systems and methods may allow advertisers and/or marketers to effectively target specific demographic segments of users, even when a portion of those users are anonymous. The disclosed systems and methods may alternatively or additionally provide advertisers, marketers, and/or web service providers with information that may be compared against user-entered or user-provided demographic information.

In the following description, numerous specific details of programming, software modules, user selections, network transactions, database queries, database structures, etc., are provided for a thorough understanding of various embodiments of the systems and methods disclosed herein. However, the system and methods disclosed can be practiced without one or more of the specific details, or can be practiced with other methods, components, materials, etc.

In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the embodiments disclosed may be changed as would be apparent to those skilled in the art. Thus, any order in the Figures or Detailed Description is for illustrative purposes only and is not meant to necessarily imply a required order.

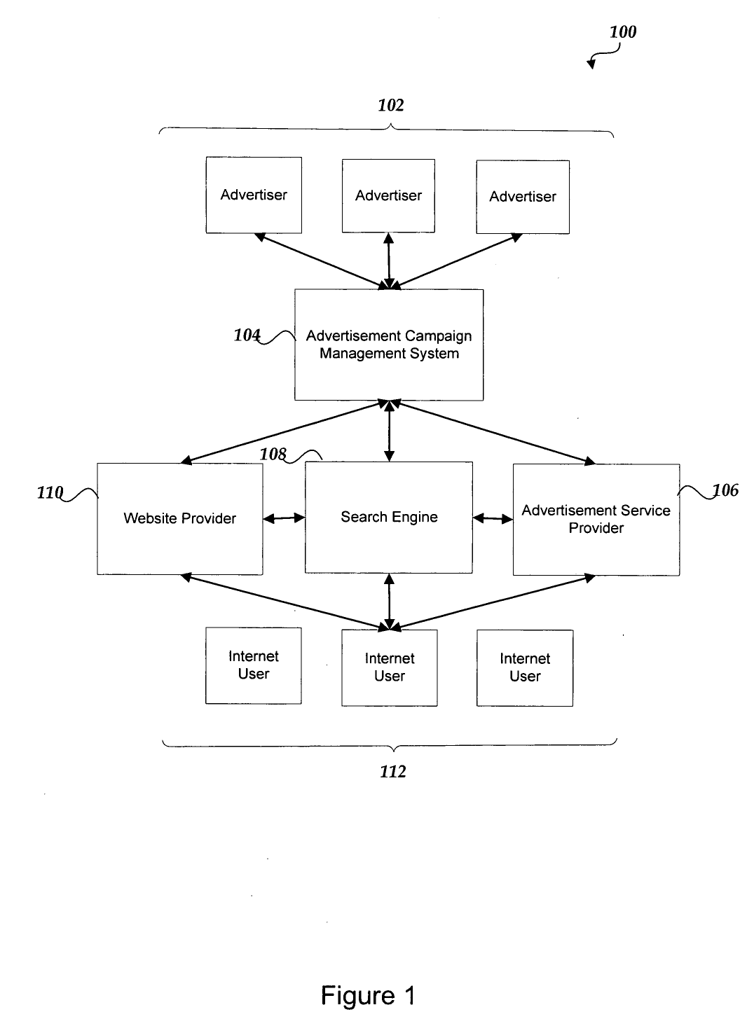

FIG. 1 is a block diagram of one embodiment of an environment 100 in which the disclosed system and method for modeling users' behavior for inferring a user's demographic information may operate. The environment 100 includes a plurality of advertisers 102, an advertisement campaign management system 104, an advertisement service provider 106, a search engine 108, a website provider 110, and a plurality of Internet users 112, generally referred to as users 112. Generally, an advertiser 102 creates an advertisement by interacting with the advertisement campaign management system 104. The advertisement may be a banner advertisement that appears on a website provided by a website provider 110 and viewed by users 112, an advertisement that is served to one of the users 112 in response to a search performed at a search engine 108, or any other type of online advertisement known in the art.

When one of the users 112 performs a search at a search engine 108, or views a website served by a website provider 110, the advertisement service provider 106 serves one or more advertisements created using the advertisement campaign management system 104. The advertisement(s) may be served based on search terms or keywords provided by the internet user or obtained from a website. Alternatively or in addition, the advertisement may be served based on other information, such as browsing history, cookie information, behavioral targeting categories, and/or behavioral targeting segments. It will be appreciated that the below-described system and method for modeling users' behavior for inferring a user's demographic information may operate in the environment described with respect to FIG. 1.

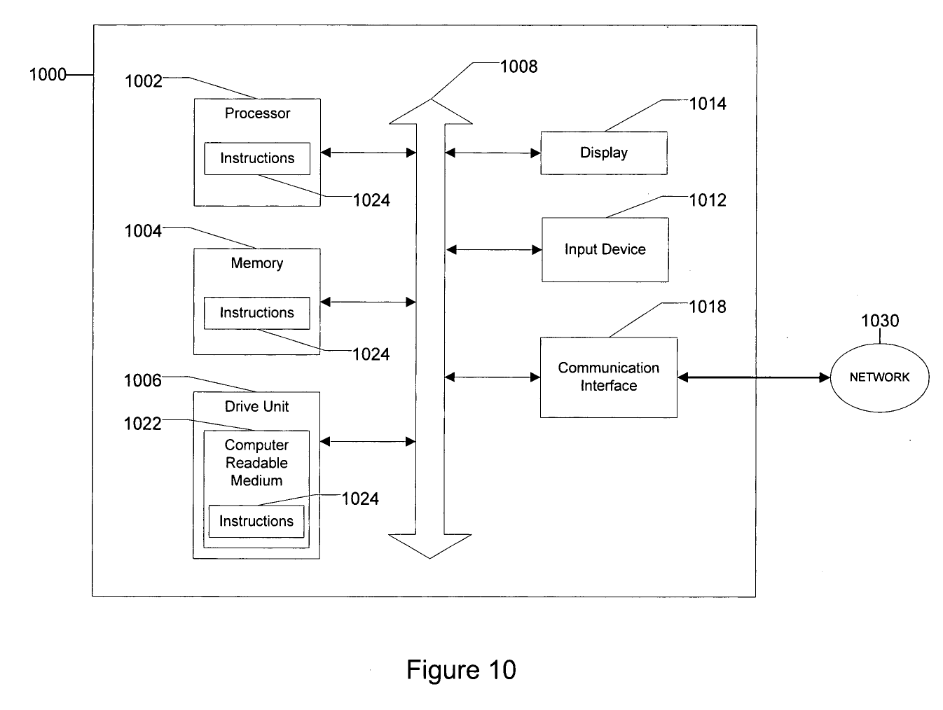

Some or all of the advertisers 102, advertisement campaign management system 104, advertisement service provider 106, search engine 108, website provider 110, and users 112 may be in communication with each other via a network (such as network 1030 in FIG. 10) and may be the system or components described below in FIG. 10. The advertisers 102, advertisement campaign management system 104, advertisement service provider 106, search engine 108, website provider 110, and users 112 may each represent multiple linked computing devices.

Advertising campaigns may be augmented with information from natural search events. As users 112 browse, their activity may be tracked through search engine queries and web beacons or the like. This activity may generate a large volume of natural search event information, in addition to sponsored search term activity. The natural search event information may be broken down into user attributes or group of attributes by categories, such as geography, technographics (the technical specifications of the computer systems used by users 112), demographics, and purchasing history, to name just a few. The attributes may be gathered in various contexts by conducting search queries, by browsing web pages or websites, or by any other method known in the art for gathering natural search event information of users 112.

The users 112 may access advertisements through a website provider 110, a search engine 108, or an advertisement service provider 106. The search engine 108 connects to the web pages and extracts or otherwise collects attribute data from natural search activity conducted by users 112. This may be accomplished by a web beacon that communicates user browser activity and information, together with attribute data composed of attributes, back to the search engine 108. The attribute data may be stored under a person, Internet Protocol (IP) address, or other user identification information. Common natural search attributes may thus also be collected through cookies and through IP address resolution, among other methods.

Examples of attributes thus extracted from users 112 include geography, such as the country, state, city, and/or zip code where the users 112 are browsing from. This type of information is often attainable through resolution of the user's IP address. Further examples of attributes include a technographic of a user's system used to access a marketer's web page 114. Technographics include, for example, connection speed, type of browser, size or quality of a monitor, an operating system, and a plug-in of a connection device (not shown) used by the user 112. This type of information would be indicative of, inter alia, how serious of a computer or online user the user 112 is based on how up-to-date or expensive his or her computer system and connection are. Further examples of attributes include demographics, such as age, age range, gender, household income range, race, ethnicity, occupation, industry, and disability. Attributes may also include a purchasing history of a user 112, which includes such information as a quantity purchased, a price paid per item, and a total price paid, either per visit or over a time period of multiple visits to a web page.

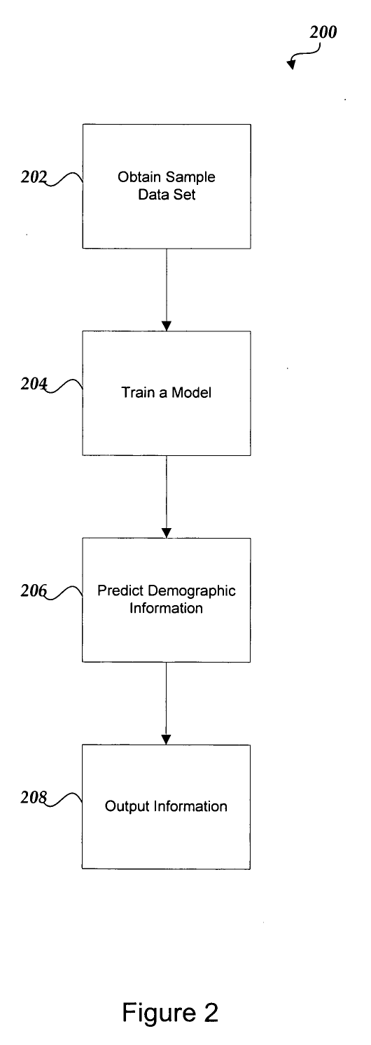

FIG. 2 is a flow chart of one embodiment of a method of creating a prediction model for user demographics. The method 200 begins with the obtaining of a sample data set at step 202. This sample data set may include user sample data, such as age information. The age information may include an integer number representing a user's age. Alternatively or in addition, the age information may include birth data information from which a user's age may be calculated or inferred. Alternatively or in addition, the age information may be an age approximation, such as information associated with an age range. For example, the age information may be a binary vector where each element in the vector represents a predefined age range and a value of “1” in a particular element within the vector represents that the user falls within that age range. Alternatively or in addition, the age information may be a probability vector.

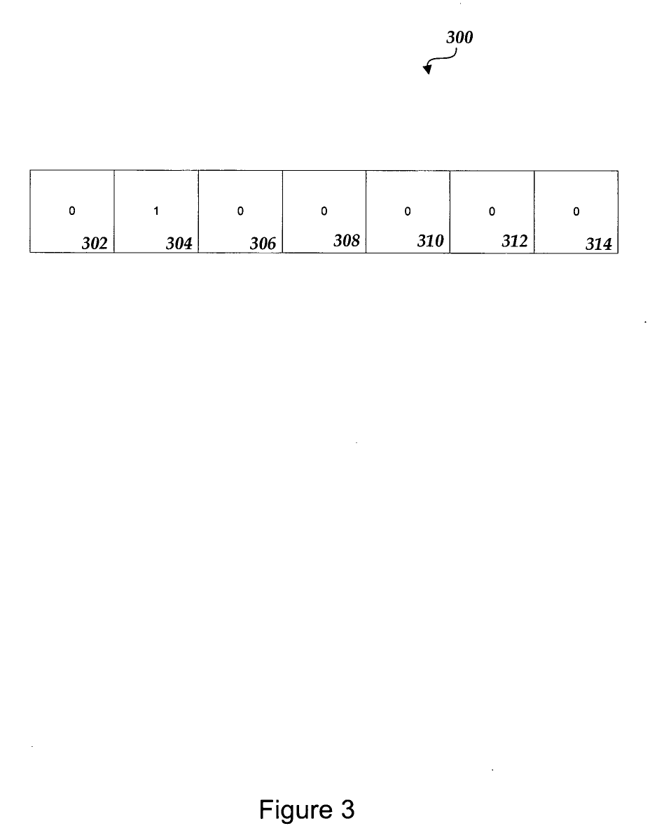

FIG. 3 illustrates an exemplary age information binary vector 300. The exemplary age information binary vector 300 contains seven elements or “bins” 302-314, where each bin represents an age range. In one example, bins 302, 304, 306, 308, 310, 312, and 314 may represent age ranges <18, 18-24, 25-34, 35-44, 45-54, 55-64, and 65+, respectively. In this example, the exemplary age information binary vector 300 may represent the age range 18-24 due to the presence of a “1” value in the bin 304. Age information binary vectors may include more or less elements, such as nine elements or five elements. Alternatively or in addition, the age information binary vector may use values other than “1” and “0” to represent age ranges.

Alternatively or in addition, the user sample data may include gender information. The gender information may include text data representing whether a user is a male or female. For example, the information may be a textual “male”, “female”, “M”, or “F”. Alternatively or in addition, the gender information may be a probability vector. Alternatively or in addition, the gender information may be a binary vector.

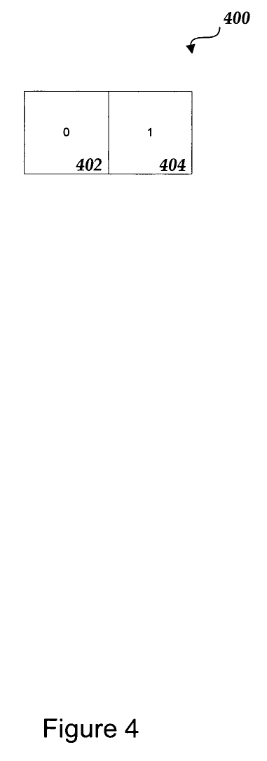

FIG. 4 illustrates an exemplary gender information binary vector 400. The exemplary gender information binary vector 400 contains two bins 402 and 404, where each bin represents a gender. In one example, bin 402 and bin 404 may represent the genders “male” and “female,” respectively. In this example, the exemplary gender information binary vector 400 may represent the gender “female” due to the presence of a “1” value in the bin 404. Gender information binary vectors may include more or less elements, such as three elements or one element. Alternatively or in addition, the gender information binary vector may use values other than “1” and “0” to represent gender information.

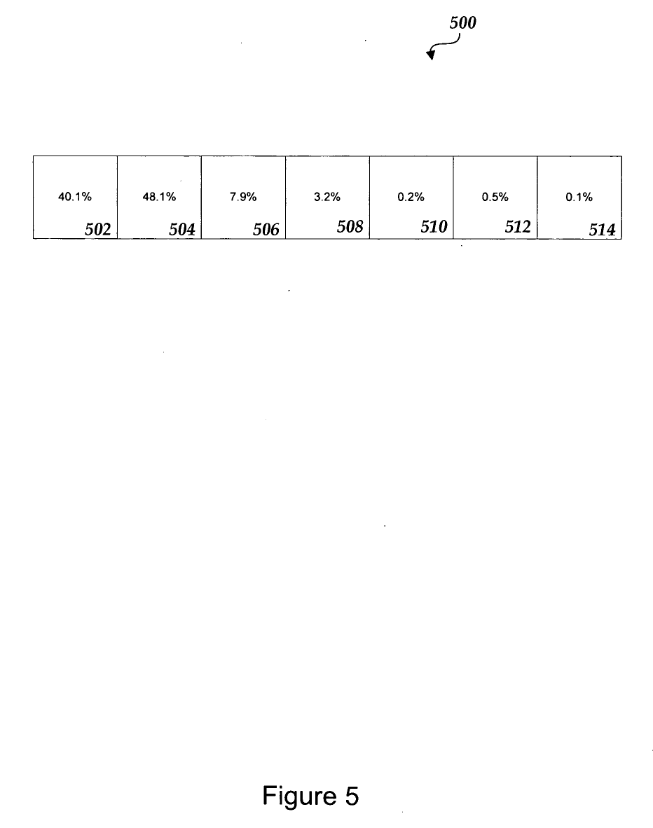

Alternatively or in addition, the user sample data may include information representing behavioral targeting categories. Behavioral targeting categories may include categories representing a user's area of interest such as Automotive, Automotive/Alternative Fuel Vehicles, Automotive/Convertible, Automotive/Price/Economy, Automotive/Sedan, Automotive/Used Consumer Packaged Goods, Corporate Services/Human Resources/Healthcare Recruiters, Entertainment, Health/Men, Health/Women, Small Sales Business, Technology, Travel, or any other category desired. Examples of a system and method for creating and using behavioral targeting categories may be disclosed in U.S. patent application Ser. No. 11/583,495, filed Oct. 18, 2006, and U.S. patent Application Ser. No. 11/394,342, filed Mar. 29, 2006, hereby incorporated herein by reference in full. Behavioral targeting category information may be represented by textual information, a probability vector similar to the age information prediction probability vector of FIG. 5, and/or a binary vector similar to the age information vector of FIG. 3. The vector elements may each represent an interest category for a user, thus the number of vector elements may vary according to the number and hierarchical taxonomy of interest categories with which an advertiser may wish to represent a user's interests. In one exemplary embodiment, the behavioral targeting category vector has five hundred and one elements. Alternatively or in addition, the vector may have between four hundred and fifty to five hundred and fifty elements. Alternatively or in addition, the vector may have between four hundred and five hundred elements. Alternatively or in addition, the vector may have between five hundred and six hundred elements.

Alternatively or in addition, the user sample data may include information representing behavioral targeting segments. Behavioral targeting segments may include “All males in California”, “All females in California”, “All Hispanics in Alaska”, “All Hispanics in Florida”, “All males whom have clicked on Ad 1”, “All males in Europe running APPLE SAFARI web browser”, “All females in the 60611 zip code using a broadband connection,” or any other segment desired. Examples of a system and method for creating and using behavioral targeting segments may be disclosed in U.S. patent application Ser. No. 11/738,195, filed Apr. 20, 2007, hereby incorporated herein by reference in full. Behavioral targeting segment information may be represented by textual information, a probability vector similar to the age information prediction probability vector of FIG. 5, and/or a binary vector similar to the age information vector of FIG. 3. The vector elements may each represent an interest segment for an advertiser, thus the number of vector elements may vary according to the number and hierarchical taxonomy of interest segments with which an advertiser wishes to work. In one exemplary embodiment, the behavioral targeting segment vector has six hundred and thirty four elements. Alternatively or in addition, the vector may have between six hundred to seven hundred elements. Alternatively or in addition, the vector may have between five hundred and fifty to six hundred and fifty elements. Alternatively or in addition, the vector may have between six hundred and fifty to seven hundred and fifty elements.

Alternatively or in addition, the user sample data may include search query information, browsing history information, internet protocol (IP) address information, geographic location information, income information, industry information, occupation information, marital status information, and/or ethnicity information. Search query information may include the text of searches performed by a user, such as “Q61=rose,garden,library,san+jose”. Browsing history information may include identifiers of web pages or web sites visited by a user, such as “www.yahoo.com, mail.yahoo.com, sports.yahoo.com,” and/or a summary of the content of those web pages or web sites. IP address information may include the IP address of the user, such as “66.94.234.13.” Geographic location information may include a city and/or state of the user, such as “Chicago, Ill.” Income information may include an income and/or income range associated with the user, such as “lowest quintile” or “$25,000-$45,000.” Industry information and occupation information may include an industry or occupation to which the user is associated, such as “federal government” or “administrative assistant.”

Referring back to FIG. 2, the method 200 may move from obtaining the sample data at step 202 to training a model at step 204. The model may be trained using the user sample data obtained at step 202. The model may be trained with a user-centric process. Alternatively or in addition, the model may be trained with a website- or webpage-centric process. The model may be trained using an optimization or classification algorithm. Alternatively or in addition, the model may be trained using logistic regression. The logistic regression may include a fast logistic regression. Alternatively or in addition, the logistic regression may include a quasi-Newton method. The quasi-Newton method may include a Davidon-Fletcher-Powell (DFP) formula, a Broyden-Fletcher-Goldfarb-Shanno (BFGS) method, a Broyden's method, a Broyden family method, a symmetric rank 1 (SR1) method, a limited-memory BFGS (L-BFGS) algorithm, and/or a L-BFGS bounded constraint (L-BFGS-B) algorithm. One model may be trained for each desired characteristic. For example, one model may be trained to predict only age information and another model may be trained to predict only gender information. Alternatively or in addition, a single model may be trained to predict all the desired characteristic information or multiple desired characteristics information. For example, a single model may be trained to predict both age information and gender information. Alternatively or in addition, combinations of single- and multi-characteristic models may be trained.

Alternatively or in addition, the model may be trained using an iterative greedy method. The iterative greedy method may start at a reach level 1 and work down to a reach level N, where the reach level 1 may be associated with a high confidence classification. The iterative greedy method may then pick a class at each iteration such that the current class distribution best approximates a base rate distribution. The best approximation may be for a least squares context. The iterative greedy method may then pick the highest scoring item for a chosen class that has not been previously picked. For this iterative greedy method, the sequence of classes may be dependent on a base rate distribution instead of a classifier output.

The method 200 may move from training a model at step 204 to predicting demographic information at step 206. The predicting demographic information at step 206 may include applying test data to the trained model to aid in verifying the accuracy of the trained model. The predicting at step 206 may apply a user-centric process. Alternatively or in addition, the predicting at step 206 may apply a website- or webpage-centric process. The predicting at step 206 may include an optimization or classification algorithm. Alternatively or in addition, the predicting at step 206 may include a greedy iterative method. Alternatively or in addition, the predicting at step 206 may include a logistic regression. The logistic regression may include a fast logistic regression. Alternatively or in addition, the logistic regression may include a quasi-Newton method. The quasi-Newton method may include a DFP formula, a BFGS method, a Broyden's method, a Broyden family method, a SR1 method, a L-BFGS algorithm, and/or a L-BFGS-B algorithm. The predicting at step 206 may use a model for each desired characteristic. For example, one model may be used to predict only age information and another model may be used to predict only gender information. Alternatively or in addition, a single model may be used to predict all the desired characteristic information or multiple desired characteristics information. For example, a single model may be used to predict both age information and gender information. Alternatively or in addition, combinations of single- and multi-characteristic models may be used. Alternatively or in addition, the predicting demographic information at step 206 may include applying non-test data, such as anonymous user data, such that advertisers may use the resulting prediction to apply targeted advertisements to the anonymous users in correspondence with their advertising campaigns.

The method 200 may move from predicting demographic information at step 206 to outputting information at step 208. The output information may include predicted demographic information. The predicted demographic information may include predicted age information, predicted gender information, predicted income information, and/or other similar information. The predicted demographic information may represent a prediction based on test data or non-test data, such as anonymous user data. The predicted demographic information may be in the form of text, a probability vector, a binary vector, and/or other similar formats. The outputting information at step 208 may include displaying the output information. Displaying the output information may include transmitting the output information to a liquid crystal display (LCD), an organic light emitting diode (OLED), a flat panel display, a solid state display, a cathode ray tube (CRT), a projector, a printer, or other now known or later developed display device for outputting determined information. Alternatively or in addition, the outputting information at step 208 may include sending the information. Sending the information may include transmitting the output information to an advertisement service provider 106, a search engine 108, a website provider 110, or any other interested party. The receiver of the transmitted output information may use the information to apply targeted advertisements to an anonymous user.

FIG. 5 illustrates an exemplary demographic information prediction probability vector 500. The exemplary demographic information prediction probability vector 500 may represent predicted age information. In one example, bins 502, 504, 506, 508, 510, 512, and 514 may represent age ranges <18, 18-24, 25-34, 35-44, 45-54, 55-64, and 65+, respectively. In this example, the exemplary demographic information prediction probability vector 500 may represent the age range 18-24 due to the presence of a “48.1%” value (the highest value among the values in the bins 502-514) in the bin 504. Demographic information prediction probability vectors may include more or fewer elements, such as nine elements or five elements for age-related vectors or one, two, or three elements for gender-related vectors. Alternatively or in addition, the demographic information probability vector may use other values to represent age ranges.

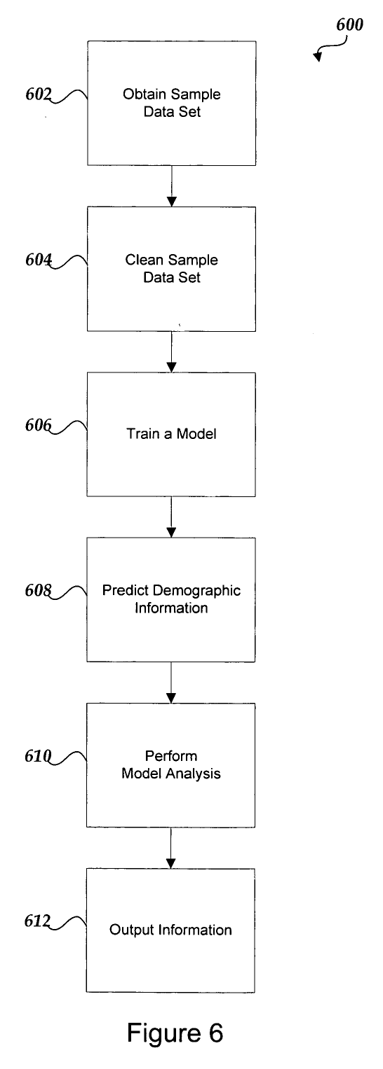

FIG. 6 is a flow chart of one embodiment of a method of creating a prediction model for user demographics. The method 600 begins with the obtaining of a sample data set at step 602. The obtaining of a sample data set at step 602 may be similar to the obtaining of a sample data set at step 202 in FIG. 2. The method 600 may move from obtaining the user sample data at step 602 to cleaning a sample data set at step 604.

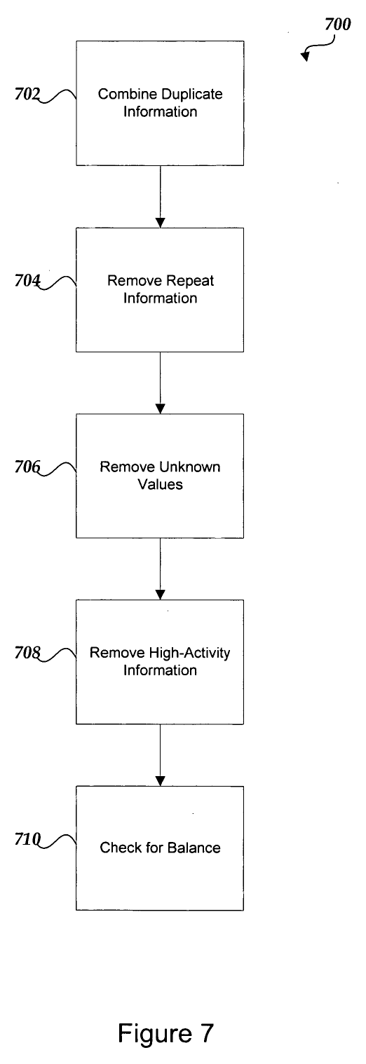

FIG. 7 is a flow chart illustrating one exemplary embodiment of a method for cleaning a sample data set at step 604. The steps described in connection with this embodiment may be included or removed as would be apparent to those skilled in the art. These steps are for illustrative purposes only and are not meant to be limiting.

The cleaning a sample data set at step 700 may include combining duplicate information at step 702. The combining duplicate information at step 702 may include combining duplicate user information within a user sample data set. Such duplicate user information may occur, e.g., where a single user has multiple user accounts. Such combining may include combining search query terms, behavioral targeting categories, and/or behavioral targeting segments for multiple accounts into one set of user sample data.

The cleaning a sample data set at step 700 may include removing repeat information at step 704. Such removing may occur, e.g., where multiple instances of the same information are associated with a single user. The removing repeat information at step 704 may include removing or combining repeat search query terms, behavioral targeting categories, and/or behavioral targeting segments for a single user within a single set of user sample data.

The cleaning a sample data set at step 700 may include removing unknown values at step 706. Such removing may occur, e.g., where data used by the logistic regression, such as age or gender information, may be indecipherable, nonsensical, or missing. The removing unknown values at step 706 may include removing the unknown value, as well as any user sample data associated with the unknown value. Alternatively or in addition, the removing unknown values at step 706 may include encoding the unknown values if they may be inferred, located, or otherwise become known.

The cleaning a sample data set at step 700 may include removing high-activity information at step 708. Such removing may occur where a large quantity of search queries may indicate that a user sample data represents a multi-user terminal, such as a computer terminal at an internet cafe or other public terminal. Alternatively or in addition, the removing may occur where conflicting demographic information exists, e.g. where a user is associated with multiple age values or multiple gender values. Alternatively or in addition, the removing may occur where a user may be associated with a large number of behavior targeting segments so as to render targeting useless or impractical.

The cleaning a sample data set at step 700 may include checking for balance at step 710. Such checking may occur to ensure a proper ratio of males to females and/or a proper ratio among age ranges in the data set, such that the model does not overly skew the prediction results.

Referring back to FIG. 6, the method 600 may move from cleaning a sample data set at step 604 to training a model at step 606. The training a model at step 606 may be similar to the training a model at step 204 in FIG. 2. The method 600 may move from training a model at step 606 to predicting demographic information at step 608. The predicting demographic information at step 608 may be similar to the predicting demographic information at step 206 in FIG. 2.

The method 600 may move from predicting demographic information at step 608 to performing model analysis at step 610. The performing model analysis at step 610 may include calculating a precision percentage for a percentage reach. Alternatively or in addition, the performing model analysis at step 610 may include composing a reach percentage versus precision percentage graph. Alternatively or in addition, the performing model analysis at step 610 may include constructing a confusion matrix for a percentage reach. Alternatively or in addition, the constructing a confusion matrix may include using an “off-by-one” approach, where accuracy may be measured by lumping adjoining cells in the confusion matrix. The method 600 may move from performing model analysis at step 610 to outputting information at step 612. The outputting at step 612 may be similar to the outputting information at step 208 in FIG. 2.

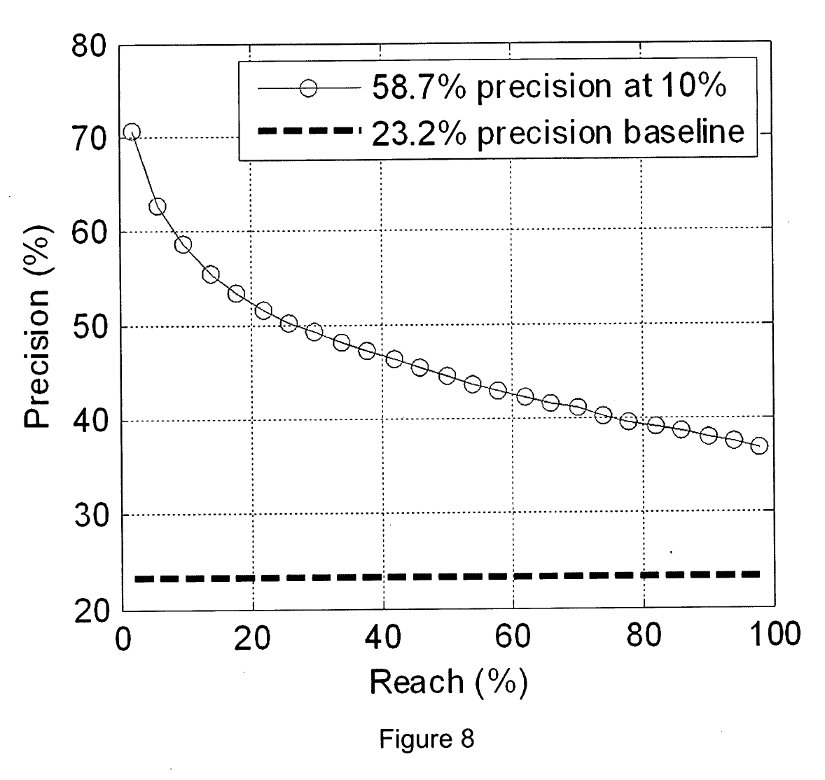

FIG. 8 illustrates an exemplary reach percentage versus precision percentage graph in accordance with the performing model analysis at step 610. As noted in FIG. 8, the results achieved using the model achieved 58.7% precision at a 10% reach.

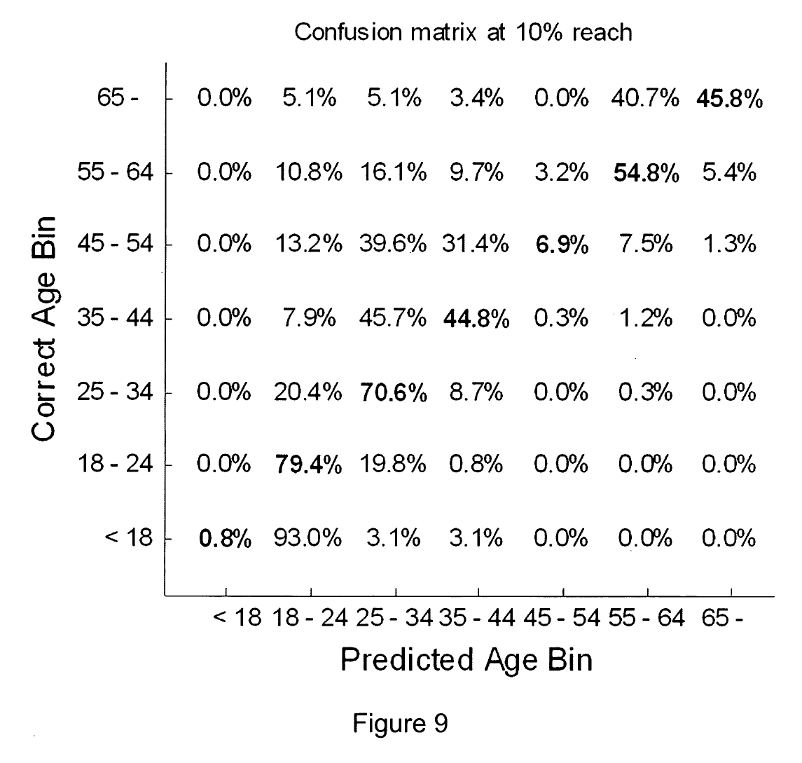

FIG. 9 illustrates an exemplary confusion matrix for a percentage reach. At a 10% reach, the model correctly predicted 79.4% of actual 18-24 year olds into the 18-24 year olds bin. Also, the model predicted 0.0% of actual 18-24 year olds into the <18 year olds bin.

FIG. 10 illustrates a general computer system 1000, which may represent one or more of the advertisers 102, an advertisement campaign management system 104, an advertisement service provider 106, a search engine 108, a website provider 110, one or more of the users 112, or any of the other computing devices referenced herein. The computer system 1000 may include a set of instructions 1024 that may be executed to cause the computer system 1000 to perform any one or more of the methods or computer based functions disclosed herein. The computer system 1000 may operate as a standalone device or may be connected, e.g., using a network 1030, to other computer systems or peripheral devices.

In a networked deployment, the computer system may operate in the capacity of a server or as a client user computer or terminal in a server-client user network environment, or as a peer computer system in a peer-to-peer (or distributed) network environment. The computer system 1000 may also be implemented as or incorporated into various devices, such as a personal computer (PC), a tablet PC, a set-top box (STB), a personal digital assistant (PDA), a mobile device, a handheld device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 1024 (sequential or otherwise) that specify actions to be taken by that machine. In a particular embodiment, the computer system 1000 may be implemented using electronic devices that provide voice, video or data communication. Further, while a single computer system 1000 may be illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1002, such as, a central processing unit (CPU), a graphics processing unit (GPU), or both. The processor 1002 may be a component in a variety of systems. For example, the processor 1002 may be part of a standard personal computer or a workstation. The processor 1002 may be one or more general processors, digital signal processors, application specific integrated circuits, field programmable gate arrays, servers, networks, digital circuits, analog circuits, combinations thereof, or other now known or later developed devices for analyzing and processing data. The processor 1002 may implement a software program, such as code generated manually (i.e., programmed).

The computer system 1000 may include a memory 1004 that can communicate via a bus 1008. The memory 1004 may be a main memory, a static memory, or a dynamic memory. The memory 1004 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 1004 may include a cache or random access memory for the processor 1002. Alternatively or in addition, the memory 1004 may be separate from the processor 1002, such as a cache memory of a processor, the system memory, or other memory. The memory 1004 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 1004 may be operable to store instructions 1024 executable by the processor 1002. The functions, acts or tasks illustrated in the figures or described herein may be performed by the programmed processor 1002 executing the instructions 1024 stored in the memory 1004. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 1000 may further include a display 1014, such as a liquid crystal display (LCD), an organic light emitting diode (OLED), a flat panel display, a solid state display, a cathode ray tube (CRT), a projector, a printer or other now known or later developed display device for outputting determined information. The display 1014 may act as an interface for the user to see the functioning of the processor 1002, or specifically as an interface with the software stored in the memory 1004 or in the drive unit 1006. Additionally, the computer system 1000 may include an input device 1012 configured to allow a user to interact with any of the components of system 1000. The input device 1012 may be a number pad, a keyboard, or a cursor control device, such as a mouse, or a joystick, touch screen display, remote control, touchpad, trackball, or any other device operative to interact with the system 1000.

The computer system 1000 may also include a disk or optical drive unit 1006. The disk drive unit 1006 may include a computer-readable medium 1022 in which one or more sets of instructions 1024, e.g. software, can be embedded. Further, the instructions 1024 may perform one or more of the methods or logic as described herein. The instructions 1024 may reside completely, or at least partially, within the memory 1004 and/or within the processor 1002 during execution by the computer system 1000. The memory 1004 and the processor 1002 also may include computer-readable media as discussed above.

The present disclosure contemplates a computer-readable medium 1022 that includes instructions 1024 or receives and executes instructions 1024 responsive to a propagated signal; so that a device connected to a network 1030 may communicate voice, video, audio, images or any other data over the network 1030. The instructions 1024 may be implemented with hardware, software and/or firmware, or any combination thereof. Further, the instructions 1024 may be transmitted or received over the network 1030 via a communication interface 1018. The communication interface 1018 may be a part of the processor 1002 or may be a separate component. The communication interface 1018 may be created in software or may be a physical connection in hardware. The communication interface 1018 may be configured to connect with a network 1030, external media, the display 1014, or any other components in system 1000, or combinations thereof. The connection with the network 1030 may be a physical connection, such as a wired Ethernet connection or may be established wirelessly as discussed below. Likewise, the additional connections with other components of the system 1000 may be physical connections or may be established wirelessly. Advertisers 102, advertisement campaign management system 104, advertisement service provider 106, search engine 108, website provider 110, and users 112 may communicate with and amongst each other through the communication interface 1018 and the network 1030.

The network 1030 may include wired networks, wireless networks, or combinations thereof. The wireless network may be a cellular telephone network using data networking standards such as 1xRTT, UMTS, HSDPA, EDGE, or EVDO, or an 802.11, 802.11b, 802.11g, 802.11n, 802.16, 802.20, or WiMax network. Further, the network 1030 may be a public network, such as the Internet, a private network, such as an intranet, or combinations thereof, and may utilize a variety of networking protocols now available or later developed including, but not limited to TCP/IP based networking protocols. Information provided by the network 1030 may be accessed through web browsers or mobile web browsers. The browser may be MICROSOFT INTERNET EXPLORER, MOZILLA FIREFOX, APPLE SAFARI, MICROSOFT POCKET INTERNET EXPLORER (POCKET IE), OPERA MINI, ACCESS NETFRONT, PALM BLAZER, NOKIA, CINGULAR MEDIA NET, BLACKBERRY, or THUNDERHAWK.

The network 1030 may include wide area networks (WAN), such as the internet, local area networks (LAN), campus area networks, metropolitan area networks, or any other networks that may allow for data communication. The network 1030 may be divided into sub-networks. The sub-networks may allow access to all of the other components connected to the network 1030 in the system 100, or the sub-networks may restrict access between the components connected to the network 1030. The network 1030 may be regarded as a public or private network connection and may include, for example, a virtual private network or an encryption or other security mechanism employed over the public Internet, or the like.

The computer-readable medium 1022 may be a single medium, or the computer-readable medium 1022 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 1022 may include a solid-state memory such as a memory card or other package that houses one or more non-volatile read-only memories. The computer-readable medium 1022 also may be a random access memory or other volatile re-writable memory. Additionally, the computer-readable medium 1022 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing may be constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

The disclosed methods, processes, programs, and/or instructions may be encoded in a signal-bearing medium, a computer-readable medium such as a memory, programmed within a device such as on one or more integrated circuits, or processed by a controller or a computer. If the methods are performed by software, the software may reside in a memory resident to or interfaced to a communication interface, or any other type of non-volatile or volatile memory. The memory may include an ordered listing of executable instructions for implementing logical functions. A logical function may be implemented through digital circuitry, through source code, through analog circuitry, or through an analog source such as that occurring through an analog electrical, audio, or video signal. The software may be embodied in any computer-readable or signal-bearing medium, for use by, or in connection with, an instruction executable system, apparatus, or device. Such a system may include a computer-based system, a processor-containing system, or another system that may selectively fetch instructions from an instruction executable system, apparatus, or device that may also execute instructions.

Although selected aspects, features, or components of the implementations are depicted as being stored in memories, all or part of the systems, including the methods and/or instructions for performing such methods consistent with the demographics from behavior system, may be stored on, distributed across, or read from other computer-readable media, for example, secondary storage devices such as hard disks, floppy disks, and CD-ROMs; a signal received from a network; or other forms of ROM or RAM either currently known or later developed.

Specific components of the computer system 1000 may include additional or different components. A processor may be implemented as a microprocessor, microcontroller, application specific integrated circuit (ASIC), discrete logic, or a combination of other types of circuits or logic. Similarly, memories may be DRAM, SRAM, Flash, or any other type of memory. Parameters, databases, and other data structures may be separately stored and managed, may be incorporated into a single memory or database, or may be logically and physically organized in many different ways. Programs or instruction sets may be parts of a single program, separate programs, or distributed across several memories and processors.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The computer-readable medium may selectively be, but is not limited to, an electronic, magnetic, optical, electromagnetic, infrared, or semiconductor system, apparatus, device, or propagation medium. A non-exhaustive list of examples of a machine-readable medium may include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A computer-readable medium may also include a tangible medium upon which software is printed, as the software may be electronically stored as an image or in another format (e.g., through an optical scan), then compiled, and/or interpreted, or otherwise processed. The processed medium may then be stored in a computer and/or machine memory.

While various embodiments of the invention have been described, it will be apparent to those of ordinary skill in the art that many more embodiments and implementations may be possible within the scope of the invention. Accordingly, the invention is not to be restricted except in light of the attached claims and their equivalents.

It is intended that the foregoing detailed description be regarded as illustrative rather than limiting, and that it be understood that it is the following claims, including all equivalents, that are intended to define the spirit and scope of this invention.

1. A method of training a user behavior model for predicting demographic attributes of anonymous users, the method comprising:
obtaining a user sample data set, wherein the user sample data set includes at least one of age information, gender information, behavioral targeting category information, behavioral targeting segment information, search query information, internet protocol (IP) address information, or geographic location information, wherein the user sample data set includes a binary vector;
cleaning the user sample data set;
training a user-centric logistic regression model using a quasi-Newton method with the user sample data set;
predicting anonymous user age information and anonymous user gender information by applying test data to the trained user-centric logistic regression model to create a prediction vector for the predicted anonymous user age information and predicted anonymous user gender information;
composing a confusion matrix based on the prediction vector for the anonymous user age information and the anonymous user gender information; and
displaying information based on at least one of the prediction vector or the confusion matrix.

2. A method of training a user behavior model for predicting demographic attributes of anonymous users, the method comprising:
obtaining a user sample data set;
training a user-centric logistic regression model with the user sample data set;
predicting anonymous user demographic information by applying test data to the trained user-centric logistic regression model; and
displaying information based on the predicted anonymous user demographic information.

3. The method of claim 2, wherein obtaining the user sample data set comprises obtaining at least one of age information, gender information, behavioral targeting category information, or behavioral targeting segment information.

4. The method of claim 2, wherein obtaining the user sample data set comprises obtaining a binary vector.

5. The method of claim 2, wherein obtaining the user sample data set comprises obtaining search query information.

6. The method of claim 2, wherein obtaining the user sample data set comprises obtaining at least one of an internet protocol (IP) address or geographic location information.

7. The method of claim 2 further comprising cleaning the user sample data set.

8. The method of claim 7, wherein cleaning the user sample data set includes:
combining duplicate user information within the user sample data set;
removing repeat search query information within the user sample data set;
removing information associated with unknown values within the user sample data set;
removing information associated with high-activity users within the user sample data set; and
checking information associated with the user sample data set for balance.

9. The method of claim 2, wherein training the user-centric logistic regression model comprises using a quasi-Newton method.

10. The method of claim 2, wherein predicting the anonymous user demographic information includes predicting at least one of predicted anonymous user age information or predicted anonymous user gender information.

11. The method of claim 2, wherein predicting anonymous user demographic information includes creating a prediction vector for the predicted anonymous user demographic information

12. The method of claim 2 further comprising composing a confusion matrix based on the predicted anonymous user demographic information.

13. A method for predicting demographic attributes of anonymous users, the method comprising:
obtaining a user sample data set, wherein the user sample data set includes at least one of age information, gender information, behavioral targeting category information, behavioral targeting segment information, search query information, internet protocol (IP) address information, or geographic location information, wherein the user sample data set includes a binary vector;
combining duplicate user information within the user sample data set;
removing repeat search query information within the user sample data set;
removing information associated with unknown values within the user sample data set;
removing information associated with high-activity users within the user sample data set;
checking information associated with the user sample data set for balance;
training a user-centric logistic regression model using a quasi-Newton method with the user sample data set;
predicting anonymous user age information and anonymous user gender information by applying anonymous user information to the trained user-centric logistic regression model to create a prediction vector for the predicted anonymous user age information and predicted anonymous user gender information, wherein the anonymous user information includes at least one of behavioral targeting category information, behavioral targeting segment information, search query information, internet protocol (IP) address information, or geographic location information; and
sending information based on the prediction vector.

14. A system for training a user behavior model for predicting demographic attributes of anonymous users, the system comprising:
an interface configured to obtain a user sample data set;
a training module configured to train a user-centric logistic regression model with the user sample data set;
a predicting module configured to predict anonymous user demographic information by applying test data to the trained user-centric logistic regression model; and
a display configured to display information based on the predicted anonymous user demographic information.

15. The system of claim 14, wherein the interface configured to obtain the user sample data set is further configured to obtain at least one of age information, gender information, behavioral targeting category information, or behavioral targeting segment information.

16. The system of claim 14, wherein the interface configured to obtain the user sample data set is further configured to obtain a binary vector.

17. The system of claim 14, wherein the interface configured to obtain the user sample data set is further configured to obtain search query information.

18. The system of claim 14, wherein the interface configured to obtain the user sample data set is further configured to obtain at least one of an internet protocol (IP) address or geographic location information.

19. The system of claim 14 further comprising a pre-processing module configured to clean the user sample data set.

20. The system of claim 19, wherein the pre-processing module configured to clean the user sample data set is further configured to:
combine duplicate user information within the user sample data set;
remove repeat search query information within the user sample data set;
remove information associated with unknown values within the user sample data set;
remove information associated with high-activity users within the user sample data set; and
check information associated with the user sample data set for balance.

21. The system of claim 14, wherein the training module configured to train the user-centric logistic regression model is further configured to use a quasi-Newton method.

22. The system of claim 14, wherein the predicting module configured to predict the anonymous user demographic information is further configured to predict at least one of predicted anonymous user age information or predicted anonymous user gender information.

23. The system of claim 14, wherein the predicting module configured to predict anonymous user demographic information is further configured to create a prediction vector for the predicted anonymous user demographic information

24. The system of claim 14 further comprising a matrix composition module configured to compose a confusion matrix based on the predicted anonymous user demographic information.

25. A system for predicting demographic attributes of anonymous users, the system comprising:
an obtaining interface configured to obtain a user sample data set, wherein the user sample data set includes at least one of age information, gender information, behavioral targeting category information, behavioral targeting segment information, search query information, internet protocol (IP) address information, or geographic location information, wherein the user sample data set includes a binary vector;
a pre-processing module configured to:
combine duplicate user information within the user sample data set;
remove repeat search query information within the user sample data set;
remove information associated with unknown values within the user sample data set;
remove information associated with high-activity users within the user sample data set; and
check information associated with the user sample data set for balance;
a training module configured to train a user-centric logistic regression model using a quasi-Newton method with the user sample data set;
a predicting module configured to predict anonymous user age information and anonymous user gender information by applying anonymous user information to the trained user-centric logistic regression model to create a prediction vector for the predicted anonymous user age information and predicted anonymous user gender information, wherein the anonymous user information includes at least one of behavioral targeting category information, behavioral targeting segment information, search query information, internet protocol (IP) address information, or geographic location information; and
a sending interface configured to send information based on the prediction vector.
